(19) United States
(12) Patent Application Publication
(10) Pub. No.: US 2019/0347652 A1
(43) Pub. Date: Nov. 14, 2019

(54) METHODOLOGY AND SYSTEM FOR SELECTING NODES TO EXECUTE CHAINCODE IN A BLOCKCHAIN ENVIRONMENT WITH A MOBILE MONEY GATEWAY

(71) Applicant: GLOBAL MOBILE FINANCE, INC., Morrisville, NC (US)

(72) Inventor: Sandra K. JOHNSON, Cary, NC (US)

(21) Appl. No.: 16/404,954

(22) Filed: May 7, 2019

Related U.S. Application Data
(60) Provisional application No. 62/670,563, filed on May 11, 2018.

(51) Int. Cl. G06Q 20/38; G06Q 20/02; G06Q 20/32; G06Q 20/10

(52) U.S. Cl. CPC G06Q 20/381; G06Q 20/027; G06Q 20/102; G06Q 20/3223; G06Q 20/389

(57) ABSTRACT

An embodiment of the present invention is directed to selecting nodes to execute chaincode components in a blockchain-based global payments funds transfer system with a mobile money gateway. Disclosed embodiments include storing account profiles, including account numbers, funds available, mobile telephone numbers, sending and receiving currencies and countries, and other relevant information. An embodiment of the present invention focuses on a portion of the response to a consumer requesting remittance to a recipient with a mobile money account. It details the specifics of how a currency exchange server (the entity) may be selected to execute the chaincode, as a result of a smart contract trigger to perform a currency exchange. After the currency exchange, the funds may be forwarded to the mobile money gateway for subsequent payment to the recipient's mobile money account.

### CROSS REFERENCE TO RELATED APPLICATIONS

This application claims priority to U.S. Provisional Application 62/670,563, filed May 11, 2018, the contents of which are incorporated herein in its entirety. This application relates to U.S. Ser. No. 16/202,262, filed Nov. 28, 2018 and PCT/US18/62726, filed Nov. 28, 2018, which claim priority to U.S. Provisional Application 62/597,341, filed Dec. 11, 2017, the contents of which are incorporated herein in their entirety.

### FIELD OF THE INVENTION

The disclosed teachings relate generally to leveraging a blockchain network to facilitate the global remittance of funds. Participants in the blockchain include finance institutions, currency exchange service providers and an innovative mobile money gateway for mobile money transfers. An embodiment of the present invention is directed to currency exchange service providers.

### BACKGROUND

Remittance solutions are a vital component of the financial infrastructure in developing countries. Many people in these countries depend upon family members and friends in the west to send money home to make ends meet. There are several issues with current global remittance solutions, including high fees, slow transaction times, security, and accessibility. While partnerships between providers, such as Viper, Western Union, WeChat, enable mobile apps to play a larger role in this space, they do not address the issues of high costs, security and some forms of accessibility. For example, current providers offer a mobile app that is associated with a bank account; however, most of the population of sub-Saharan Africa (SSA) and developing world is unbanked. In fact, more citizens in SSA own mobile devices than bank accounts. The number of unique subscribers is expected to reach approximately 500 million by the year 2020. Mobility is driving innovation and digital and financial inclusion in SSA and beyond. For example, m-Pesa is a popular mobile money solution in Kenya.

Current systems do not address the issues associated with an end-to-end global remittance solution.

These and other drawbacks exist.

### SUMMARY OF THE INVENTION

Accordingly, one aspect of the invention is to address one or more of the drawbacks set forth above. An embodiment of the present invention is directed to a system for executing a chaincode in a blockchain-based mobile money gateway. The system comprises: a blockchain mobile money gateway that receives, from a mobile device, a transfer request from a requester to transfer funds to a recipient and responsive to the transfer request, executing a first smart contract to verify the requester's financial information and confirm the requester's funds availability at a finance processing server; and a blockchain network that facilitates communication with the blockchain mobile money gateway and the finance processing server and a currency exchange server; wherein upon verification of the requester's financial information and confirmation of funds availability, invoking execution of a second smart contract to initiate a transfer of funds at the currency exchange server; and executing code on a plurality of nodes of the blockchain network to perform a determination of a currency exchange (FX) provider to conduct the transfer of funds, wherein the determination comprises: performing a comparison of a plurality of currency exchange (FX) providers and selecting an optimal currency exchange (FX) provider based on the comparison to conduct the transfer of funds from a requester currency to a recipient currency.

Another embodiment of the present invention is directed to method for executing a chaincode in a blockchain-based mobile money gateway. The method comprises the steps of: receiving, from a mobile device, a transfer request from a requester to transfer funds to a recipient and responsive to the transfer request; executing, via a blockchain mobile money gateway, a first smart contract to verify the requester's financial information and confirm the requester's funds availability at a finance processing server, wherein a blockchain network that facilitates communication with the blockchain mobile money gateway and the finance processing server and a currency exchange server; and upon verification of the requester's financial information and confirmation of funds availability, invoking execution of a second smart contract to initiate a transfer of funds at the currency exchange server; and executing code on a plurality of nodes of the blockchain network to perform a determination of a currency exchange (FX) provider to conduct the transfer of funds, wherein the determination comprises; performing a comparison of a plurality of currency exchange (FX) providers and selecting an optimal currency exchange (FX) provider based on the comparison to conduct the transfer of funds from a requester currency to a recipient currency.

According to another embodiment of the present invention, a computer-readable medium comprising instructions which, when executed by a computer, cause the computer to carry out steps of: receiving, from a mobile device, a transfer request from a requester to transfer funds to a recipient and responsive to the transfer request; executing, via a blockchain mobile money gateway, a first smart contract to verify the requester's financial information and confirm the requester's funds availability at a finance processing server, wherein a blockchain network that facilitates communication with the blockchain mobile money gateway and the finance processing server and a currency exchange server; and upon verification of the requester's financial information and confirmation of funds availability, invoking execution of a second smart contract to initiate a transfer of funds at the currency exchange server; and executing code on a plurality of nodes of the blockchain network to perform a determination of a currency exchange (FX) provider to conduct the transfer of funds, wherein the determination comprises: performing a comparison of a plurality of currency exchange (FX) providers and selecting an optimal currency exchange (FX) provider based on the comparison to conduct the transfer of funds from a requester currency to a recipient currency.

The computer implemented system, method and medium described herein provide unique advantages to entities, organizations, merchants and other users (e.g., consumers, etc.), according to various embodiments of the invention. According to an embodiment of the present invention, Blockchain technology may be leveraged to reduce the global remittance transaction fees. Distributed ledger technology (DLT) can reform and transform the delivery of public and private services in many fields of endeavor, including finance it is a technology-focused method for storing, recording and transferring digital assets. It is also the foundation technology for cryptocurrency, and has the advantages of security and efficiency. The innovative mobile money gateway provides reduction in fees, increased security and further offer the accessibility convenience provided by mobile money. These and other advantages will be described more fully in the following detailed description.

### BRIEF DESCRIPTION OF THE DRAWINGS

In order to facilitate a fuller understanding of the present inventions, reference is now made to the appended drawings. These drawings should not be construed as limiting the present inventions, but are intended to be exemplary only.

FIG. 1 is a schematic block diagram illustrating an exemplary system 100 for processing electronic transactions in accordance with an embodiment of the present invention.

FIG. 2 is a schematic block diagram illustrating a blockchain mobile money gateway 106 for the processing of electronic transactions, in accordance with an embodiment of the present invention.

FIG. 3 is a schematic block diagram illustrating an embodiment of a finance processing server for the processing of electronic transactions, in accordance with an embodiment of the present invention.

FIG. 4 is a flowchart illustrating an exemplary method for processing a funds transfer and currency exchange request, in accordance with an embodiment of the present invention.

FIGS. 5A and 5B are flowcharts illustrating an exemplary method for selecting a currency exchange server to process an exchange request, in accordance with an embodiment of the present invention.

FIG. 6 is a block diagram for selecting a currency exchange service to execute the chaincode, in accordance with an embodiment of the present invention.

### DESCRIPTION OF EMBODIMENTS OF THE INVENTION

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to selecting nodes to execute chaincode components in a blockchain-based global payments funds transfer system with a mobile money gateway. Disclosed embodiments include storing account profiles, including account numbers, funds available, mobile telephone numbers, sending and receiving currencies and countries, and other relevant information. An embodiment of the present invention focuses on a portion of the response to a consumer requesting remittance to a recipient with a mobile money account. It details the specifics of how a currency exchange server (the entity) may be selected to execute the chaincode, as a result of a smart contract trigger to perform a currency exchange. After the currency exchange, the funds may be forwarded to the mobile money gateway for subsequent payment to the recipient's mobile money account.

In accordance with an embodiment of the present invention, Blockchain refers to a ledger of facts, replicated across several computers assembled in a peer-to-peer network. Facts can be anything from a monetary transaction to content signature. Members of the network may or may not be anonymous entities called nodes. Communication inside the network takes advantage of cryptography to securely identify the sender and receiver. When a node wants to add a fact to the ledger, a consensus forms in the network to determine where this fact should appear in the lodger; this consensus is called a block.

According to an embodiment of the present invention, Smart Contract enables the exchange of money, property, shares, or anything of value in a transparent, conflict-free way while avoiding the services of a middleman. It may be executed as part of processing a transaction in a blockchain network. A smart contract may also be denoted chaincode,

Consumer Account generally refers to an account owned by a consumer and used by a money service business (MSB) for money processing. It may or may not be a financial account.

Finance Transaction Account generally refers to a financial account owned by a consumer from which funds may be used to transmit to a currency exchange for global remittance.

Currency Exchange (FX) Account generally refers to a financial account that temporarily holds funds transferred into, and out of, a currency exchanged. It may be used to temporarily hold funds processed by the FX.

Remittance Account generally refers to a financial holding account that is part of the blockchain mobile money gateway. It may be used to temporarily hold funds processed by and transferred from the currency exchange before pushing to the mobile money account of a recipient, and vice versa.

Money Services Business (MSB) may represent an entity doing business in one or more of the following capacities: 1) currency dealer or exchanger; 2) check casher; 3) issuer of traveler's checks, money orders or stored value; 4) seller or redeemer of traveler's checks, money orders or stored value; 5) money transmitter; or 6) a postal service. It is not a bank or other entity registered with, and regulated and examined by a country's financial regulators.

Mobile Network Operator (MNO) may represent a wireless service provider, wireless carrier or other provider that provides wireless services to customers. The provider may also own or control infrastructure needed to sell and provide such services.

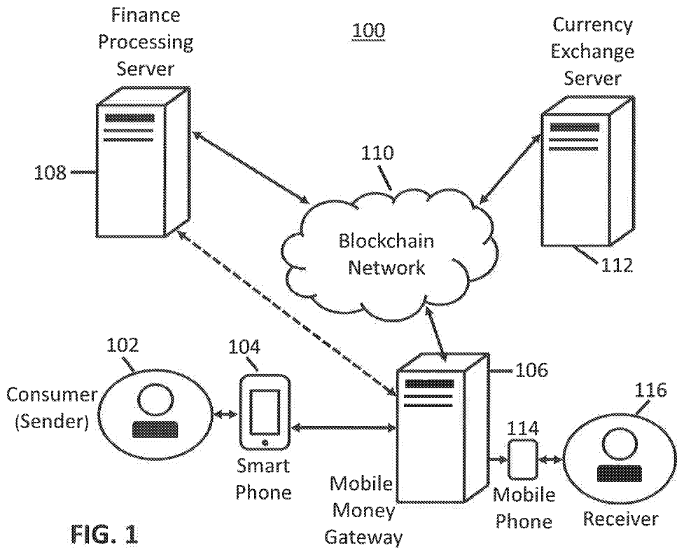

FIG. 1 is a schematic block diagram illustrating an exemplary system 100 for processing electronic transactions in accordance with an embodiment of the present invention. According to an embodiment of the present invention, the system 100 may include a consumer 102 with a smart phone 104 (or other mobile device), a blockchain mobile money gateway 106, a finance processing server 108, a blockchain network 110, and a currency exchange server 112, which are described below.

According to an embodiment of the present invention, the system 100 may represent a network data processing system with a network of computers in which the illustrative embodiments may be implemented. The system 100 includes a consumer 102 with a smart phone 104. The consumer represents a person, a software program, a virtual program or any other entity that has possession of, can emulate, or other otherwise issue commands to execute an electronic program on the smart phone 104. This may include a remittance app executing on the smart phone 104. The system 100 may include a blockchain mobile money gateway 106 which accepts and processes commands from the mobile app executing on the smart phone 104. The blockchain mobile money gateway 106 typically includes one or more processors and may include a mainframe computer, a workstation, a desktop computer, a computer system in a computer rack, and the like.

A server-side remittance app executing on the blockchain mobile money gateway 106 may invoke the execution of a smart contract in response to a request to transfer funds to a recipient in another country. The smart contract execution leverages the blockchain network 110 to invoke a smart contract executing on the finance processing server 108 to verify the requester's finance information and confirm it has funds for the transfer. Once the finance processing server 108 verifies the request and confirms availability of funds, it may invoke the execution of a smart contract on the currency exchange server 112 via the blockchain network 110. This enables the currency exchange server 112 to initiate, via the blockchain network 110, the transfer of consumer 102 (sender) funds from the finance processing server 108 to the currency exchange server 112. When the funds are received by the currency exchange server 112, it may exchange the sender funds for the receiver funds in the targeted currency and further invoke a smart contract executing on the blockchain mobile money gateway 106 to transfer the receiver funds from the currency exchange server 112 to the blockchain mobile money gateway 106 via the blockchain network 110. The blockchain mobile money gateway 106 may receive the funds via the blockchain network 110 and then initiate a transfer to push the receiver funds to the mobile money account associated with mobile phone 114 of recipient 116.

According to another embodiment of the present invention, the blockchain mobile money gateway 106 may request the consumer 102 account verification and availability of funds outside of the blockchain network 110. Once the handshaking for consumer 102 verification and funds availability between the finance processing server 108 and the blockchain mobile money gateway 106 completes, then the blockchain mobile money gateway 106 may invoke a smart contract to execute, via the blockchain network 110 the transfer of funds from the finance processing server 108 to the currency exchange server 112. Other variations and embodiments will be apparent to persons having skill in the relevant art.

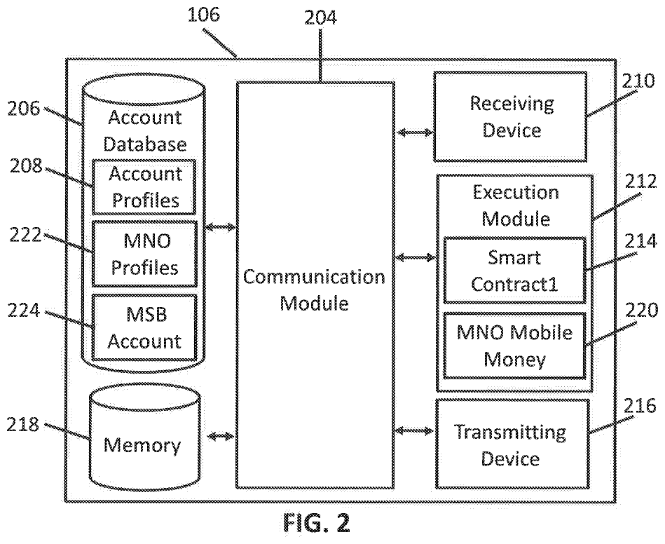

FIG. 2 is a schematic block diagram illustrating a blockchain mobile money gateway 106 for the processing of electronic transactions, in accordance with an embodiment of the present invention. The mobile app client executing on the smart phone 104 may issue a command, such as a transaction request, that may be received by the blockchain mobile money gateway 106 through the receiving device 210. The receiving device 210 may be configured to receive data over one or more network protocols. In some instances, the receiving device 210 may be configured to receive data from consumers 102, computing devices, finance processing servers 108, blockchain networks, currency exchange servers 112 and other entities via alternative networks, such as the Internet. In some embodiments, the receiving device 210 may include multiple devices, such as different receiving devices for receiving data over different networks. The receiving device 210 may electronically receive data signals that are transmitted, where data may be superimposed on the data signal and decoded, parsed, read, and otherwise obtained via receipt of the data signal by the receiving device 210. In some instances, the receiving device 210 may include a parsing module for parsing the received data signal to obtain the data superimposed thereon. For example, the receiving device 210 may include a parser program configured to receive and transform the received data signal into usable input for the functions performed by the processing device to carry out the methods and systems described herein.

The receiving device 210 communicates the request to the execution module 212 via the communication module 204. The execution module 212 may include one or more computational engines, which may be one or more processors of a general-purpose computer, special purpose computer, or other programmable data processing apparatus to produce a machine, such that the instructions, which execute via the processor of the computer or other programmable data processing apparatus, implement the features specified in the flowchart and/or block diagram block or blocks or descriptions herein.

The communication module 204 may be configured to transmit data between modules, engines, databases, memories, and other components of the blockchain mobile money gateway 106 for use in performing the features discussed herein. The communication module 204 may include one or more communication types and utilize various communication methods for communications within a computing device. For example, the communication module may include a bus, contact pin connectors, wires, etc. In some embodiments, the communication module 204 may also be configured to communicate between internal components of the blockchain mobile money gateway 106 and external components of the blockchain mobile money gateway 106, such as externally connected databases, display devices, input devices, etc.

The blockchain mobile money gateway 106 may include an account database 206. The account database 206 may be configured to store a plurality of consumer 102 and recipient 116 account profiles 208 using a suitable data storage format and schema. The account database 206 may be a relational database that utilizes structured query language for the storage, identification, modifying, updating, accessing, etc. of structured data sets stored therein. Each consumer 102 or recipient 116 account profile 208 may be a structured data set configured to store data related to a transaction account. Each consumer 102 or recipient 116 account profile 208 may include a primary account number, an account balance, a postal mailing address, an email address, an international mobile telephone number, an account balance, sender country, sender currency, receiver currency, receiver 116 international mobile number, timestamp, date or any additional information that may be used for know-your-customer (KYC) and anti-money laundering (AML) regulations. In some instances, the consumer 102 or recipient 116 account profile 208 may also include additional identification information, such as an identification value to be used in allocation requests and other data exchanges. The consumer 102 or recipient 116 account profiles 208 may also include additional information suitable for consumer 102 or recipient 116 service programs, vendor optimizations, and regulations, such as product data, offer data, loyalty data, reward data, usage data, currency-exchange data, mobile money data, fraud scoring, validity of funds, and transaction/account controls. The consumer 102 or recipient 116 account profile 208 may also include additional information suitable for performing the functions discussed herein, such as communication details for transmitting smart contract requests and transactions to the consumer 102 or recipient 116, the finance processing server 108 or the currency exchange server 112 through the blockchain network 110.

Depending upon the request, the execution module 212 may then query the account database 206 to determine the existence of a consumer 102 or recipient 116 account profile 208, which is stored in the memory 218 of the blockchain mobile money gateway 106. The memory 218 may be configured to store data for use by the blockchain mobile money gateway 106 in performing the functions discussed herein. The memory 218 may be configured to store data using suitable data formatting methods and schema and may be any suitable type of memory, such as read-only memory, random access memory, etc. The memory 218 may include, for example, currency and geographic location associations, international telephone number and mobile network operator (MNO) associations, encryption keys and algorithms, communication protocols and standards, data formatting standards and protocols, program code for execution modules and application programs of the processing device, and other data that may be suitable for use by the blockchain mobile money gateway 106 in performance of the functions disclosed herein as will be apparent to persons having skill in the relevant art.

If a consumer 102 or recipient 116 account profile 208 does not exist, then the execution module 212 may proceed to create the consumer 102 or recipient 116 account profile 208. Those who are skilled in the art will understand the various embodiments needed for consumer 102 or recipient 116 account profile 208 creation. Once the execution module 212 verifies a valid consumer 102 or recipient 116 account profile 208, it may proceed to invoke a smart contract execution to execute on the relevant finance processing server 108 via the blockchain network 110. This may be done by the execution module 212 issuing the smart contract execution request to the communication module 204 and on to the transmitting device 216 and the finance processing server 108 through the blockchain network 110.

The transmitting device 216 may be configured to transmit data over one or more networks via one or more network protocols. In some embodiments, the transmitting device 216 may be configured to transmit data to consumers 102, computing devices, finance processing servers 108, blockchain networks 110, and other entities via alternative networks such as the Internet. In some embodiments, the transmitting device 216 may include multiple devices, such as different transmitting devices for transmitting data over different networks. The transmitting device 216 may electronically transmit data signals that have data superimposed that may be parsed by a receiving computing device. In some instances, the transmitting device 218 may include one or more modules for superimposing, encoding, and otherwise formatting data into data signals suitable for transmission.

The transmitting device may be configured to electronically transmit data signals to blockchain networks 110 or computing nodes associated herewith, which may be superimposed with blockchain transactions as records of mobile money currency exchange for posting to a corresponding blockchain. In some embodiments, the transmitting device 216 may he further configured to electronically transmit data signals to computing devices associated with a consumer 102.

The execution module 212 may also include a smart contract1 represented by 214. The smart contract may represent a computer program product, as previously described, that is executed by participants (nodes) in the blockchain. The smart contract1 represented by 214 may be invoked when the currency exchange server 112 completes a currency exchange. The receiving device 210 may receive the request via the blockchain network 110 and communicate it to the execution module 212 via the communication module 204. The smart contract1 represented by 214 may complete by depositing the receiver funds into the MSB account 224. The MSB account 224 information may be stored in account database 206. The account database 206 may be configured to store a plurality of MSB account 224 profiles using a suitable data storage format and schema. The account database 206 may be a relational database that utilizes structured query language for the storage, identification, modifying, updating, accessing, etc. of structured data sets stored therein. Each MSB account 224 profile may be a structured data set configured to store data related to a transaction account. Each MSB account 224 profile may include the recipient's name, international mobile telephone number, amount of funds to be received, MNO, receiver currency, receiver country, sender's name and contact information, timestamp, date, and any additional information that may be required for know-your-customer (KYC) and anti-money laundering (AML) regulations. In some instances, the MSB account 224 profile may also include additional identification information, such as an identification value to be used in allocation requests and other data exchanges. The MSB account 224 profile may also include additional information suitable for consumer 102 and receiver 116 service programs, vendor optimizations, and regulations, such as product data, offer data, loyalty data, reward data, usage data, currency-exchange data, mobile money data, fraud scoring, validity of funds, and transaction/account controls. The MSB account 224 profile may also include additional information suitable for performing the functions discussed herein, such as communication details for transmitting smart contract requests and transactions to the recipient 116. The finance processing server 108 or the currency exchange server 112 through the blockchain network 110.

Once the smart contract1 214 completes, the execution module 212 may execute the MNO mobile money 220 program to push the funds to the intended receiver's 116 mobile money account associated with its mobile telephone 114.

The MNO mobile money program 220 may represent a server-based computer program, as discussed above. The MNO mobile money program 220 may access the MNO profiles 222 via the communication module 204. The account database 206 may be configured to store a plurality of MNO profiles 222 using a suitable data storage format and schema. The account database 206 may be a relational database that utilizes structured query language for the storage, identification, modifying, updating, accessing, etc. of structured data sets stored therein. Each MNO profile 222 may be a structured data set configured to store data related to a MNO. Each MNO profile 222 may include at least the name of the MNO operator, country or countries of operation, MNO-specific information for pushing and pulling data from mobile money accounts, MNO customer account information and regulations, MNO fees, MNO API information, required KYC and AML information for regulations, and other relevant information. The MNO profile 222 may also include additional information suitable for performing the functions discussed herein, such as communication details for pushing and pulling receiver funds, communicating with the currency exchange server 112 or the blockchain network 110.

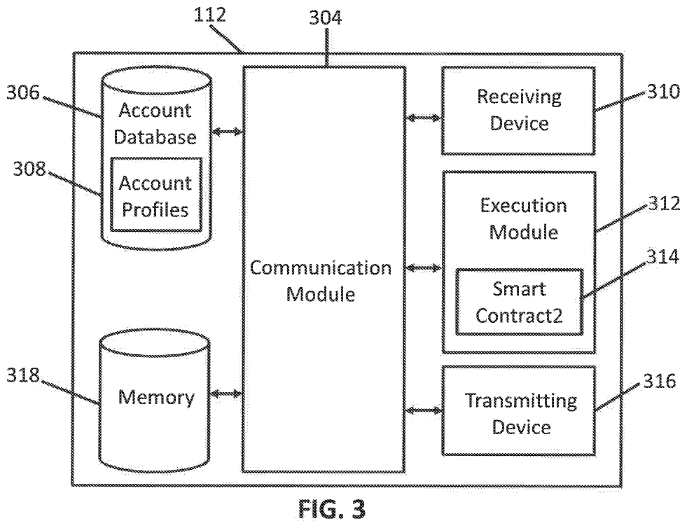

FIG. 3 is a schematic block diagram illustrating an embodiment of a currency exchange server 112-for the processing of electronic transactions, in accordance with an embodiment of the present invention. A smart contract executing on the finance processing server 108 may invoke the execution the smart contract2 314 by sending the request to the receiving device 310. The smart contract2 314 may represent a computer program product that is executed by participants (nodes) in the blockchain.

The invocation request may be received by the finance processing server 108 through the receiving device 310. This receiving device 310 may include components, and functions, such as receiving device 210. The device may communicate the request to the execution module 312 via the communication module 304. Execution module 312 may include components, and functions, such as execution module 212. The communication module 304 may be configured to transmit data between modules, engines, databases, memories, and other components of the finance processing server 108 for use in performing the functions discussed herein. The communication module 304 may include one or more communication types and utilize various communication methods for communications within a computing device. For example, the communication module may include a bus, contact pin connectors, wires, etc. According to an embodiment of the present invention, the communication module 304 may also be configured to communicate between internal components of the finance processing server 108 and external components of the finance processing server 108, such as externally connected databases, display devices, input devices, etc.

The current exchange server 112 may include an account database 306. The account database 306 may be configured to store a plurality of currency exchange (FX) account profiles 308 using a suitable data storage format and schema. For example, the account database 306 may be a relational database that utilizes structured query language for the storage, identification, modifying, updating, accessing, etc. of structured data sets stored therein. Each FX account profile 308 may be a structured data set configured to store data related to a transaction account. Each FX account profile 308 may include a primary account number, an account balance, a postal mailing address, an email address, an international mobile telephone number, an account balance, sender country, sender currency, receiver currency, timestamp, date or any additional information that may be required for know-your-customer (KYC) and anti-money laundering (AML) regulations. In some instances, the FX account profile 308 may also include additional identification information, such as an identification value to be used in allocation requests and other data exchanges. The FX account profile 308 may also include additional information suitable for consumer 102 service programs, vendor optimizations, and regulations, such as product data, offer data, loyalty data, reward data, usage data, currency-exchange data, mobile money data, fraud scoring, validity of funds, and transaction account controls. The FX account profile 308 may also include additional information suitable for performing the functions discussed herein, such as communication details for transmitting smart contract requests and transactions to the consumer 102, the finance processing server 108 or the blockchain mobile money gateway 106 through the blockchain network 110.

Depending upon the request, the execution module 312 may then query the account database 306 to determine the existence of a FX account profile 308 for the consumer 102. The account database 306 may contain a plurality of FX account profiles 308. The FX account profile 308 may be stored in the memory 318 of the currency exchange server 112. The memory 318 may include components, and functions, like memory 218, as discussed above. Once the execution module 312 invokes the smart contract2 314 to exchange the currency. Upon completion, it may trigger a request through the communication module 304 and on to the transmitting device 316 to the blockchain mobile money gateway 106 through the blockchain network 110. The transmitting device 316 may include components, and functions, like transmitting device 216, as discussed above.

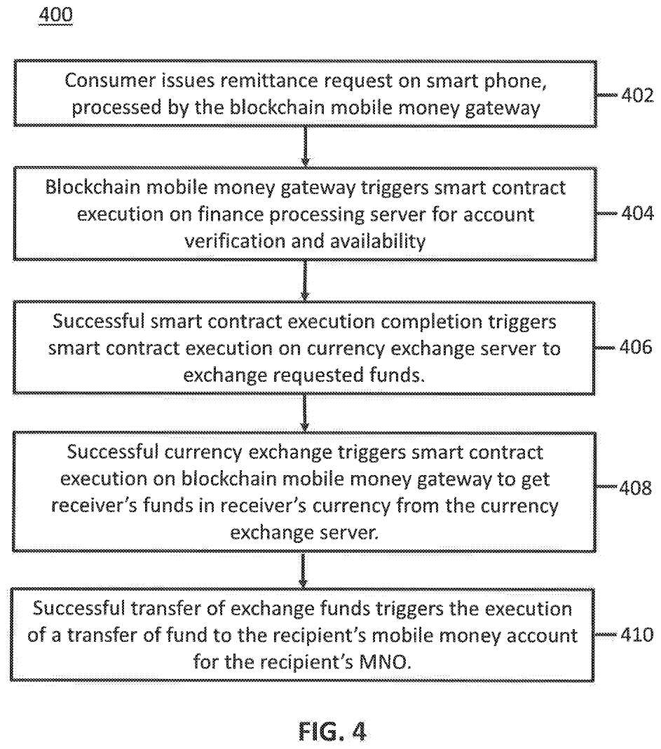

FIG. 4 is flowchart illustrating an embodiment of the blockchain mobile money environment 100 for the processing of electronic transactions, in accordance with an embodiment of the present invention. At 402, when a consumer 102 leverages its smart phone 104 to remit funds internationally, it may processed by the blockchain mobile money gateway 106. Part of this processing may include ensuring that the consumer is registered with the remittance service, etc. Next, at 404, blockchain mobile money gateway 106 may invoke a smart contract execution on the finance processing server 108 for account verification and availability. When this task is completed, the finance processing server 108 may invoke a smart contract execution on the currency exchange server 112 to conduct an exchange from the sender currency to the receiver currency, at 406. When this completes, at 408, a smart contract execution may be invoked on the blockchain mobile money gateway 106 to transfer funds from the currency exchange server 112 to the blockchain mobile money gateway 106 in the already exchanged currency. At 410, the blockchain mobile money gateway 106 may execute the transfer of the receiver's funds into its mobile money account for the relevant MNO.

According to an embodiment of the present invention, a smart contract may execute on all nodes in the blockchain. There are specific code components in the smart contract to determine which of the nodes executing the smart contract are to handle the funds (e.g., exchange currency, transfer exchanged currency to blockchain mobile money gateway, etc.). The specifics of this determination are described in further detail in U.S. Ser. No. 16/202,262, filed Nov. 28, 2018 and PCT/US18/62726, filed Nov. 28, 2018, which claim priority to U.S. Provisional Application 62/597,341, filed Dec. 11, 2017, the contents of which are incorporated herein in their entirety.

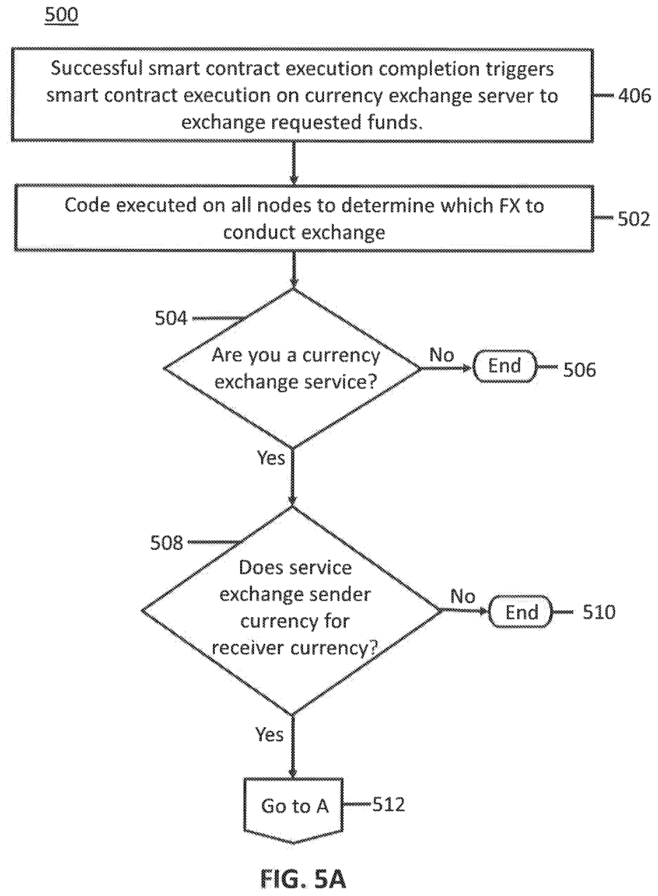

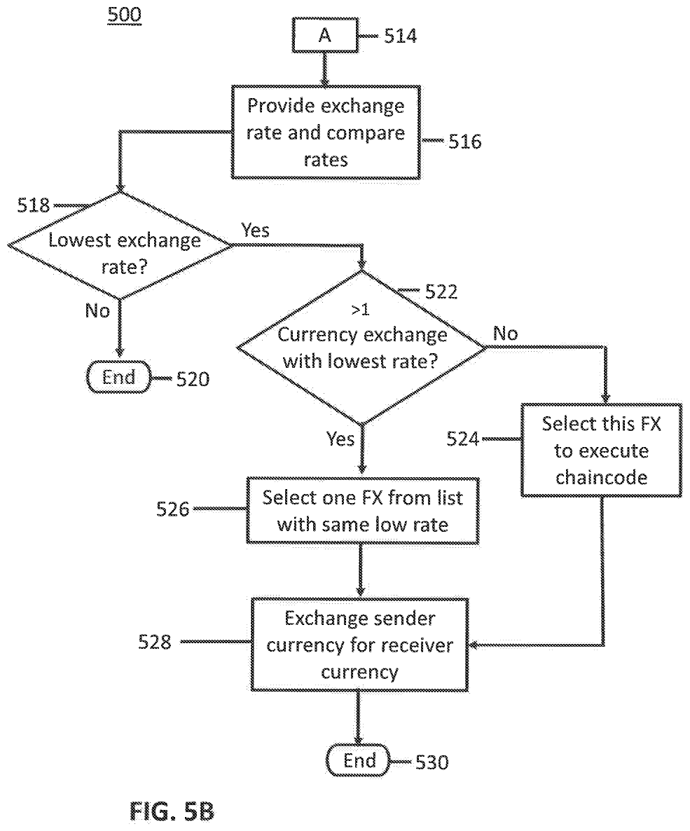

FIGS. 5A and 5B are flowcharts illustrating an embodiment of the methodology 500 for selecting a foreign exchange service provider to execute a chaincode to perform an exchange, in accordance with an embodiment of the present invention. When smart contract execution on finance processing server 404 successfully completes, it triggers a smart contract execution targeted for a currency exchange server 406. As illustrated in FIG. 5A, all nodes within the blockchain environment, including several that may be currency exchange servers, initially execute the chaincode 502. The chaincode executing on these nodes 502 may ask if the node is a currency exchange service 504. If it is not a currency exchange service, then the chaincode executing on the nodes ends 506. If the node is a currency exchange service, then the chaincode may ask if the service exchanges the sender currency for the receiver currency 508. If the answer is no, then the chaincode executing on the node ends 510. If the answer is yes, then the chaincode execution advances to the next step 512.

FIG. 5B presents the next steps in the flow, according to an embodiment of the currency exchange service selection methodology 500. In the next step 514 the chaincode may determine an exchange rate for the service 516. The exchange rates for the relevant currency exchange servers may he compared 516 to determine which service has the lowest rate 518 (or optimal rate). If a currency exchange service does not have the lowest exchange rate (or optimal rate), then the chaincode on that node ends execution 520. If the chaincode executing on the node has the lowest rate (or optimal rate), then the chaincode may determine if there are other servers that offer the same or comparable low rate 522 (or optimal rate). If no other currency exchange server offers this low rate (or comparable rate), then the exchange server continues to execute the chaincode 524.

If there are other exchange servers that offer the same low rate (or comparable rate), then one of them is selected 526 to perform the currency exchange. An additional embodiment of this invention may limit the review to exchange rates of the currency exchange servers that have reached this section of the chaincode 518 within a specific time window. This time window may be a constant value (e.g., 50 milliseconds, etc.) and/or a variable that changes according to a total number of currency exchange servers, geographical locations of the servers, etc. According to an exemplary embodiment, if there are X or fewer exchange servers, then the time window is Y; if there are more than X servers, then the time window is Z. Furthermore, the number of exchange servers may change over the course of time (or other factor/condition), so the value of the time window may be directly or indirectly associated with this change in number. Furthermore, some exchange servers may be geographically dispersed, while others may be clustered, in such situations, a time window may dynamically change according to the degree of geographic clustering.

Independent of whether one or more currency exchanges offer the lowest exchange rate (or optimal rate), the selected exchange service performs the actual exchange from the sender currency to the receiver currency 528. Next, the chaincode ends 530 the execution of this section of code.

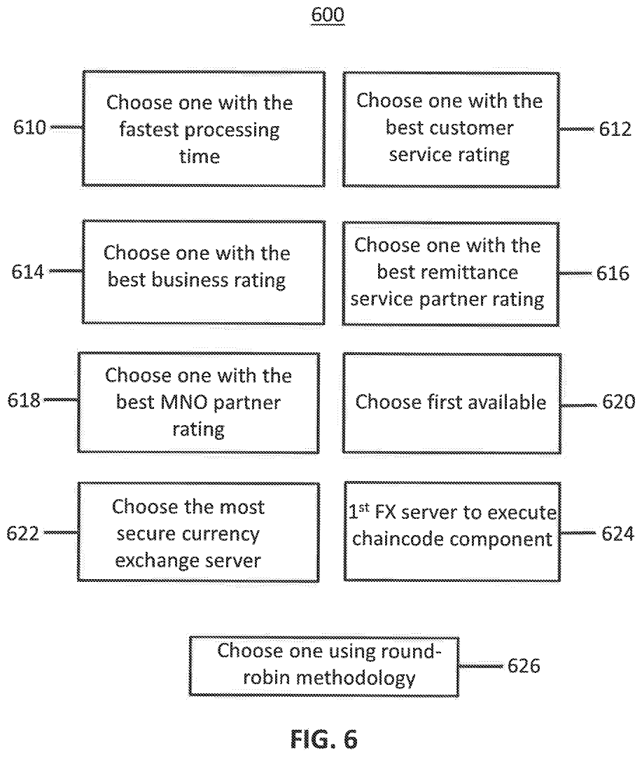

FIG. 6 is a block diagram for selecting a currency exchange service to execute the chaincode, in accordance with an embodiment of the present invention. As shown in FIG. 6, various methods 600 may be used to select the currency exchange service, from multiple competing services, to perform the currency exchange. This may include: choosing a server with a fastest currency exchange processing time 610, a best customer service rating 612, a best business rating 614, a best remittance service partner rating 616, a best MNO partner rating 618, a first available 620, a most secure 622, a first to execute this specific component of the chaincode 624 or round-robin 626. Also, an embodiment of the present invention may involve choosing a combination of two or more options (610, 612, 614, 616, 618, 620, 622, 624 or 626), up to and including all of them. The methods of FIG. 6 are exemplary and other variations may be applied and implemented in accordance with the various embodiments of the present invention.

Reference throughout this specification to “one embodiment,” “an embodiment,” or similar language means that a feature, structure, or characteristic described about the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved, it will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labelled as modules, to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

1. A system for executing a chaincode in a blockchain based mobile money gateway, the system comprising:
a blockchain mobile money gateway that receives, from a mobile device, a transfer request from a requester to transfer funds to a recipient and responsive to the transfer request, executing a first smart contract to verify the requester's financial information and confirm the requester's funds availability at a finance processing server; and
a blockchain network that facilitates communication with the blockchain mobile money gateway and the finance processing server and a currency exchange server;
wherein upon verification of the requester's financial information and confirmation of funds availability,
invoking execution of a second smart contract to initiate a transfer of funds at the currency exchange server; and
executing code on a plurality of nodes of the blockchain network to perform a determination of a currency exchange (FX) provider to conduct the transfer of funds, wherein the determination comprises: performing a comparison of a plurality of currency exchange (FX) providers and selecting an optimal currency exchange (FX) provider based on the comparison to conduct the transfer of finds from a requester currency to a recipient currency.

2. The system of claim 1, wherein the comparison compares exchange rates associated with the plurality of currency exchange (FX) providers.

3. The system of claim 1, wherein the comparison compares processing times associated with the plurality of currency exchange (FX) providers.

4. The system of claim 1, wherein the comparison compares service or business ratings associated with the plurality of currency exchange (FX) providers.

5. The system of claim 1, wherein the optimal currency exchange (FX) provider represents a most secure currency server exchange.

6. The system of claim 1, wherein the chaincode represents a smart contract,

7. The system of claim 1, wherein the funds are pushed into a mobile money account associated with mobile identifier of the recipient.

8. The system of claim 1, wherein the transfer request comprises a remittance request.

9. The system of claim 8, wherein the remittance request is associated with a finance institution, which is part of the blockchain network.

10. The system of claim 8, wherein the remittance request is associated with a finance institution, which is not part of the blockchain network.

11. A method for executing a chaincode in a blockchain-based mobile money gateway, the method comprising the steps of:
receiving, from a mobile device, a transfer request from a requester to transfer funds to a recipient and responsive to the transfer request;
executing, via a blockchain mobile money gateway, a first smart contract to verify the requester's financial information and confirm the requester's funds availability at a finance processing server, wherein a blockchain network that facilitates communication with the blockchain mobile money gateway and the finance processing server and a currency exchange server; and
upon verification of the requester's financial information and confirmation of funds availability, invoking execution of a second smart contract to initiate a transfer of funds at the currency exchange server; and executing code on a plurality of nodes of the blockchain network to perform a determination of a currency exchange (FX) provider to conduct the transfer of funds, wherein the determination comprises: performing a comparison of a plurality of currency exchange (FX) providers and selecting an optimal currency exchange (FX) provider based on the comparison to conduct the transfer of funds from a requester currency to a recipient currency.

12. The method of claim 11, wherein the comparison compares exchange rates associated with the plurality of currency exchange (FX) providers.

13. The method of claim 11, wherein the comparison compares processing times associated with the plurality of currency exchange (FX) providers.

14. The method of claim 11, wherein the comparison compares service or business ratings associated with the plurality of currency exchange (FX) providers.

15. The method of claim 11, wherein the optimal currency exchange (FX) provider represents a most secure currency server exchange.

16. The method of claim 11, wherein the chaincode represents a smart contract.

17. The method of claim 11, wherein the funds are pushed into a mobile money account associated with mobile identifier of the recipient.

18. The method of claim 11, wherein the transfer request comprises a remittance request.

19. The method of claim 18, wherein the remittance request is associated with a finance institution, which is part of the blockchain network.

20. A computer-readable medium comprising instructions which, when executed by a computer, cause the computer to carry out steps of:
receiving, from a mobile device, a transfer request from a requester to transfer funds to a recipient and responsive to the transfer request;
executing, via a blockchain mobile money gateway, a first smart contract to verify the requester's financial information and confirm the requester's funds availability at a finance processing server, wherein a blockchain network that facilitates communication with the blockchain mobile money gateway and the finance processing server and a currency exchange server; and
upon verification of the requester's financial information and confirmation of funds availability, invoking execution of a second smart contract to initiate a transfer of funds at the currency exchange server; and executing code on a plurality of nodes of the blockchain network to perform a determination of a currency exchange (FX) provider to conduct the transfer of funds, wherein the determination comprises: performing a comparison of a plurality of currency exchange (FX) providers and selecting an optimal currency exchange (FX) provider based on the comparison to conduct the transfer of funds from a requester currency to a recipient currency.
